(19) United States
(12) Patent Application Publication
(10) Pub. No.: US 2009/0094531 A1
(43) Pub. Date: Apr. 9, 2009

(54) TELEPHONE CALL AS RENDEZVOUS MECHANISM FOR DATA SHARING BETWEEN USERS

(75) Inventors: Damon V. Danieli, Bellevue, WA (US); Abhiram Khune, Sammamish, WA (US); Robert I. Brown, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/867,704

(22) Filed: Oct. 5, 2007

(51) Int. Cl. H04M 3/42; G06F 15/16; G06F 3/01

(52) U.S. Cl. 715/753; 379/142.04; 379/202.01; 709/202

(57) ABSTRACT

A mechanism for transferring files that leverages the user-friendly process of making a phone call. The phone call provides sufficient context to enable the sharing of data. Conversely, selected data that was previously shared can initiate an alternative means of communication (e.g., a phone call, email, etc.). The mechanism separates data into a separate application from voice, and allows users to continue using the familiar telephone while obtaining all of the benefits that multimodal applications (voice and data) provide. By making a phone call, data sharing capability is activated between the call parties. Moreover, sharing can continue after the call ends. The phone call serves as an introduction mechanism for the sharing services, which are available from then on, regardless of when the phone call finishes.

### BACKGROUND

The sharing of music, pictures, and other data files between users is desirable. However, in everyday practice transmitting files between people is more difficult than transmitting voice. This is despite the fact that both are simply the transfer of bits between two endpoints in a network.

The telephone is the single universally adopted solution, and the notion of telephone numbers and telephone etiquette are deeply embedded into cultures over all living generations. As long as one party knows the other party's phone number, conversation can be achieved. Even if the other party's number is unknown, there are standard directories to find the unknown number quickly and easily (e.g., via white pages and operator assistance, and more recently, web sites).

In contrast to the ease associated with voice communications, there are a number of major challenges that need to be overcome with a file sharing experience. Firstly, unlike the telephone, there is no universal convention for performing file sharing. There are a number of popular alternative approaches, each of which presents a challenge. With respect to email attachments, the user must know the recipient's current email address, even if the recipient's phone number is already known, which offers no help. There are not standardized ways to which to find an email address. Moreover, the process of attaching multiple files to an email message, sending it to a recipient, receiving it and saving the attached files is cumbersome.

With respect to text messaging technologies such as Instant Messaging (IM), personal file transfer using IM clients requires knowing the recipient IM address, being a member of the same IM cloud and each user needs to be in the other user's buddy list. Furthermore, the users capable of using file transfer greatly outnumber the users who can simply text message.

Another alternative approach is to post to a website that the recipient can view. However, a website requires the sharer to communicate the URL (uniform resource locator) to the recipient. Moreover, a website either makes the files available to the general public or requires the sharer to set access permissions. This is cumbersome for the sharer and requires the recipient to have an account in the same domain, which may mean yet another logon for the recipient to remember.

Yet another alternative approach is sending an MMS (multimedia message service) message between cell phones. However, MMS is not commonly used for transferring between computers because of the cost to the user and thus, is unattractive compared to simply sending packets freely over the Internet.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes a mechanism for transferring files that leverages the user-friendly process of making a phone call. Moreover, the mechanism does not require any additional knowledge in order to perform the file transfer. The phone call triggers sufficient context to enable the sharing of data.

The disclosed mechanism separates data into a separate application from voice, and allows users to continue using the familiar telephone while obtaining all of the benefits that multimodal applications (voice and data) provide. The user is not required to do anything special. By making a phone call, data sharing capability is activated between the call parties. This is in contrast to conventional approaches that require phones with data-sharing applications where the user has to type phone numbers into the sharing application and perform 3^{rd} party call control (e.g., select a “start conference” button in the application so that sharing becomes available and the phones of all participants begin to ring).

Moreover, sharing can continue after the call ends. The phone call serves as an introduction mechanism for the sharing services, which are available from then on, regardless of when the phone call finishes.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a communications system for data sharing in accordance with the disclosed architecture.

FIG. 2 illustrates a more detailed exemplary system that facilitates data sharing in response to establishing a call between at least two parties.

FIG. 3 illustrates an exemplary abstract VoIP system implementation of the disclosed data sharing architecture.

FIG. 4 illustrates a computer-implemented method of communicating data.

FIG. 5 illustrates a flow diagram for an exemplary subscription process for data sharing session.

FIG. 6 illustrates a flow diagram for an exemplary notification process after the subscription process of FIG. 5.

FIG. 7 illustrates a method of data sharing based on a phone call.

FIG. 8 illustrates a method of establishing a communications session based on shared data.

FIG. 9 illustrates a method of identifying shared data.

FIG. 10A and FIG. 10B illustrate a set of UI panels for two users in an exemplary data sharing scenario.

FIG. 11 illustrates a block diagram of a computing system operable to execute the disclosed call session/data sharing architecture.

### DETAILED DESCRIPTION

Disclosed is a mechanism that automatically facilitates data file sharing between at least two call parties based on initiation of a telephone call. The data files can include, but are not limited to, images, video files, audio files, text documents, etc. Based on the call, context information of derived such that the data sharing can then be established, occur and even continue after the call has ended. There is no requirement to switch the existing systems over to newer technology-legacy systems can obtain the benefits disclosed herein.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

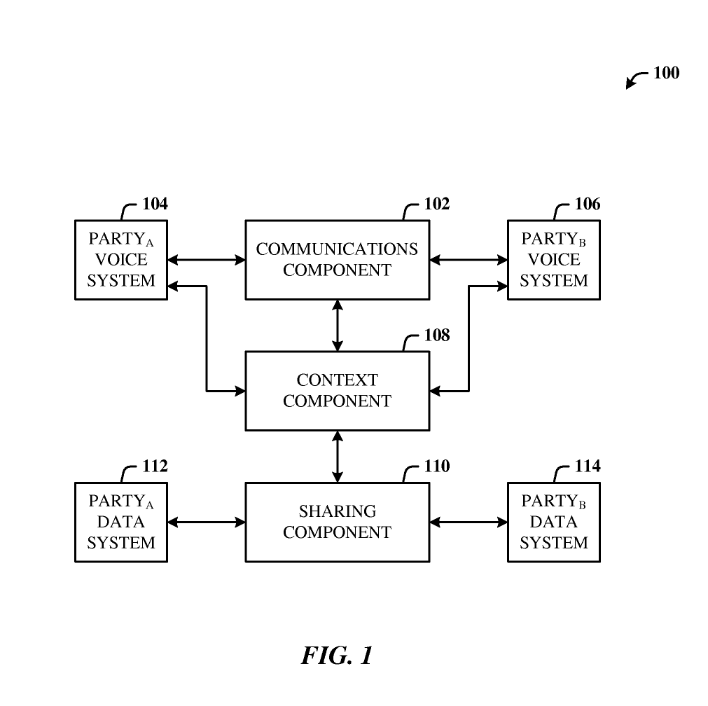

FIG. 1 illustrates a communications system 100 for data sharing in accordance with the disclosed architecture. The system 100 includes a communications component 102 for establishing a call session between call parties via a party A voice system 104 and a party B voice system 106. A context component 108 is provided for determining contextual information of the call parties based on the call session. In support thereof, the context component 108 interfaces to the communications component 102 and/or the call party systems (104 and 106) to obtain call party information such as phone numbers (or other information) that can then be used to make a data sharing connection. A sharing component 110 is provided for automatically establishing an independent data sharing session between call party data systems (e.g., a party A data system 112 and a party B data system 114) based on the contextual information.

The communications component 102 can include a voice application (or agent) and the sharing component 110 can include a data sharing application (or agent), the applications installed and operating independently. Thus, during the call (or voice) session or even after the call has ended, the data sharing session can continue. In other words, the telephone call serves as the introduction mechanism for the data sharing services. It will also be described herein that the data can serve as a means for establishing the voice session.

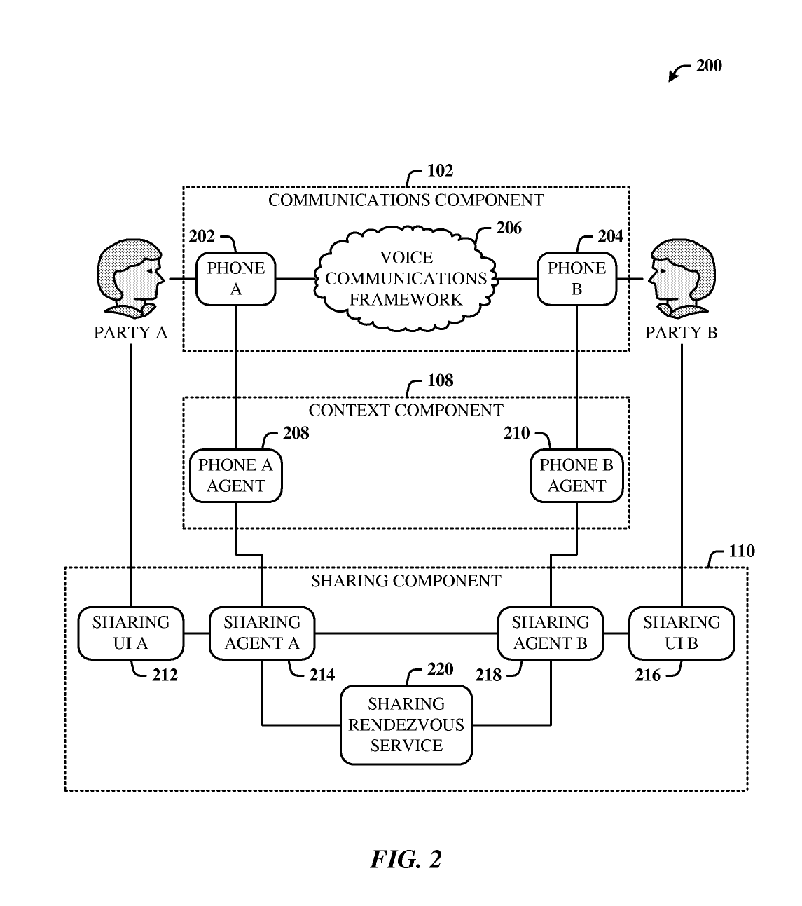

FIG. 2 illustrates a more detailed exemplary system 200 that facilitates data sharing in response to establishing a call between at least two parties. In this particular system 200, the communications component 102 includes a party A phone 202 for a party A and a party B phone 204 for a party B via which a voice session is established over a voice communications framework 206. The framework 206 can be the PSTN (public switched telephone network), an IP network such as the Internet that facilitates IP calls via VoIP (voice over IP) or other IP-based technologies, and/or a wireless cellular network (e.g., 2G, 3G, 4G, etc.).

The context component 108 can include phone agents that provide context information (e.g., a phone associated with each party) for the party user phones. For example, a party A phone agent 208 (denoted Phone A Agent) operates in association with party A phone 202 and a party B phone agent 210 (denoted Phone B Agent) operates in association with party B phone 204.

The sharing component 110 is illustrated as including a party A sharing user interface (UI) 212, a party A sharing agent 214, a party B sharing UI 216, and a party B sharing agent 218. The sharing component 110 also includes a sharing rendezvous service 220 that provides relationship information between a party's phone identity and the party's sharing agent. In other words, when the voice session is established, the party phone numbers can be ascertained. These phone numbers can further be associated in a user profile, for example, with party data sharing systems such as a desktop computer system, portable computer, PDA, other phone, vehicle-mounted computers, etc.

The function of the phone agent is to interact with the phone and/or phone network (depending on implementation) to determine the user identity and/or the identity of the user to which the call has been placed. The function also includes interacting with the sharing agent to provide the sharing agent with details of the user identity and/or the identity of the user to which the call has been placed. The specific information provided depends on the implementation. For example, the other phone number of the other party is an identifier; alternatively, the IP address or email address of the other party is also a good identifier.

The phone agents (208 and 210) are an enhancement to the switching function of the party's phone network. Depending on the phone network implementation, the phone agents (208 and 210) can be software and/or firmware located on the party's premises, in the telecom service provider's network, and/or provided by a third-party Internet service provider, for example.

The sharing UIs (212 and 216) are applications via which the party interacts to share data with another party. The function of the sharing UI is to provide a data sharing UI to the user. The sharing UI interacts with the sharing agent to send and receive data. The sharing UI can be implemented on the party's PC, cell phone, network-connected digital photo frame, and/or as a service on a website, for example.

The sharing agents (214 and 218) are responsible for locating and interacting with each other (and other sharing agents in a three or more multi-party call session) to share data. Functions of the sharing agent include interacting with the sharing UI, interacting with the phone agent to determine the unique identities of the agent user and the other call party in the phone network, and interacting with the sharing rendezvous service. The sharing agent interact with the rendezvous service to provide a mapping between the network address of the sharing agent and the unique identity in the phone network of the corresponding user, and discover the other party's sharing agent network address based on the other party's unique identity in the phone network.

The sharing agent also interacts with the other party's sharing agent to transfer data over the network and to associate the shared data with the identity of the user who shared the data. This association enables future interaction scenarios. For example, when a user views a picture received from a friend, the user can select the picture to automatically initiate and establish a call to the friend. Additionally, when a user is in conversation with a friend, the user can view the data that the friend had previously shared with the user. The sharing agent, depending on implementation, may reside in the network, in the user device, and/or in the user premises.

The sharing rendezvous service is responsible for providing a mapping between a user identity in the phone network and the network address of the user's sharing agent. Specific implementation options can vary. For example, the service can be implemented as a centralized network service, similar to or as an extension or application of technologies such as the DNS (domain name server) or SIP (session initiation protocol) registrar. The service can also be implemented as a distributed service using a peer-to-peer (P2P) discovery protocol, such as is used in conventional P2P data sharing solutions.

The phone agents and sharing agents can be implemented as separate installable applications that operate independently by interacting to provide the disclosed solution to sharing data. Again, these separate applications can be installed in the user premises equipment, provider premises, and/or user device(s).

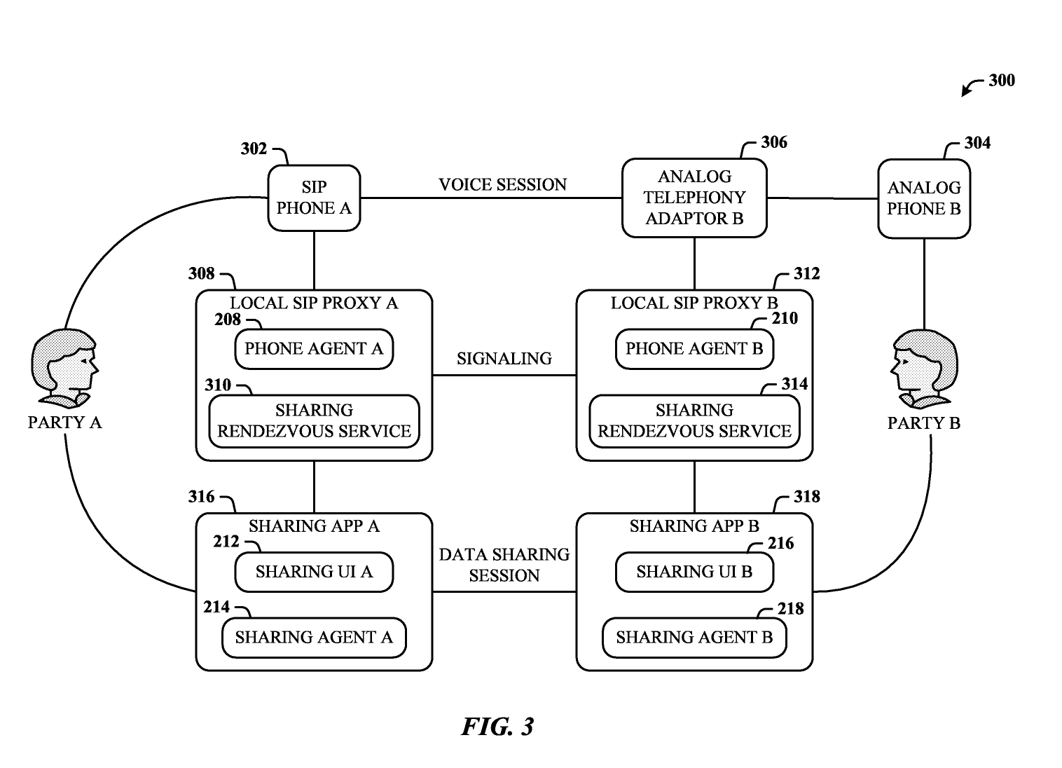

FIG. 3 illustrates an exemplary abstract VoIP system 300 implementation of the disclosed data sharing architecture. In this particular embodiment, party A is a SIP user that employs a SIP phone 302 (denoted SIP Phone A) to call a party B who uses an analog phone 304. Thus, the voice session is conducted between party A and the party B via an analog telephone adaptor (ATA) 306 (for analog/digital voice communications). The ATA 306 simulates the connection of traditional telephones to the system 300. The SIP phone 302 is a generic VoIP telephone implementing SIP and RTP (realtime transport protocol) (and/or RTCP-realtime control protocol), and provisioned to use a local SIP proxy 308 (denoted Local SIP Proxy A).

The local proxy 308 is an enhanced SIP proxy running locally to the SIP phone 302. In this particular implementation, the proxy 308 implements two functions for the abstract system 300: the phone agent 208 and a sharing rendezvous service 310. The enhanced proxy 308 operates in conjunction with a local SIP proxy 312 (denoted Local SIP Proxy B) of the analog phone 304. Similarly, in this particular implementation, the proxy 312 can implement two functions for the abstract system 300: the phone agent 210 and a sharing rendezvous service 314. One or both of the rendezvous services (310 or/and 314) can be utilized. In such circumstances, the rendezvous services (310 and 314) can employ synchronization to maintain the same data and mappings.

A sharing application 316 for the SIP user party A can also be an implementation of two functions in the abstract system 300: the sharing UI 212 via which party A selects pictures (or other media or files) to share and which displays pictures (or other media or files) received; and sharing agent 214, now implemented as a SIP user agent, using an RTP-like protocol for file transfer. A sharing application 318 for the analog user party B can also be an implementation of two functions in the abstract system 300: the sharing UI 216 via which party B selects pictures to share and which displays pictures received; and sharing agent 218.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

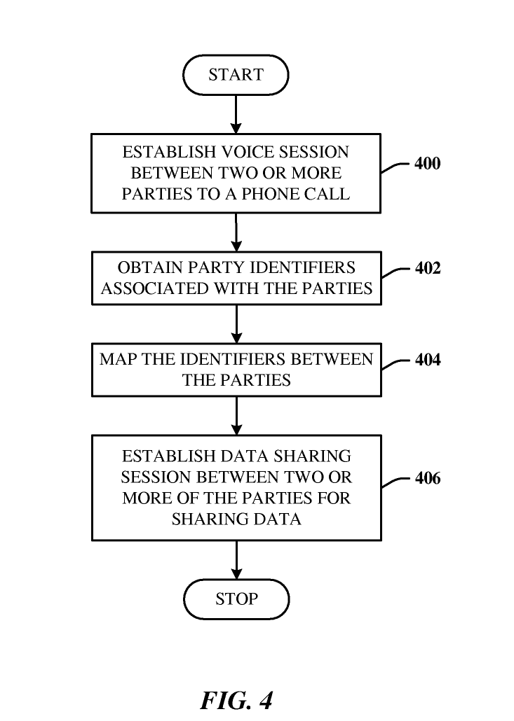

FIG. 4 illustrates a computer-implemented method of communicating data. At 400, a voice session is established between parties to a phone call. At 402, party identifiers associated with the parties are obtained. At 404, the identifiers are mapped between the parties. At 406, a data sharing session is established between the parties for sharing data and which data sharing session is independent of the voice session.

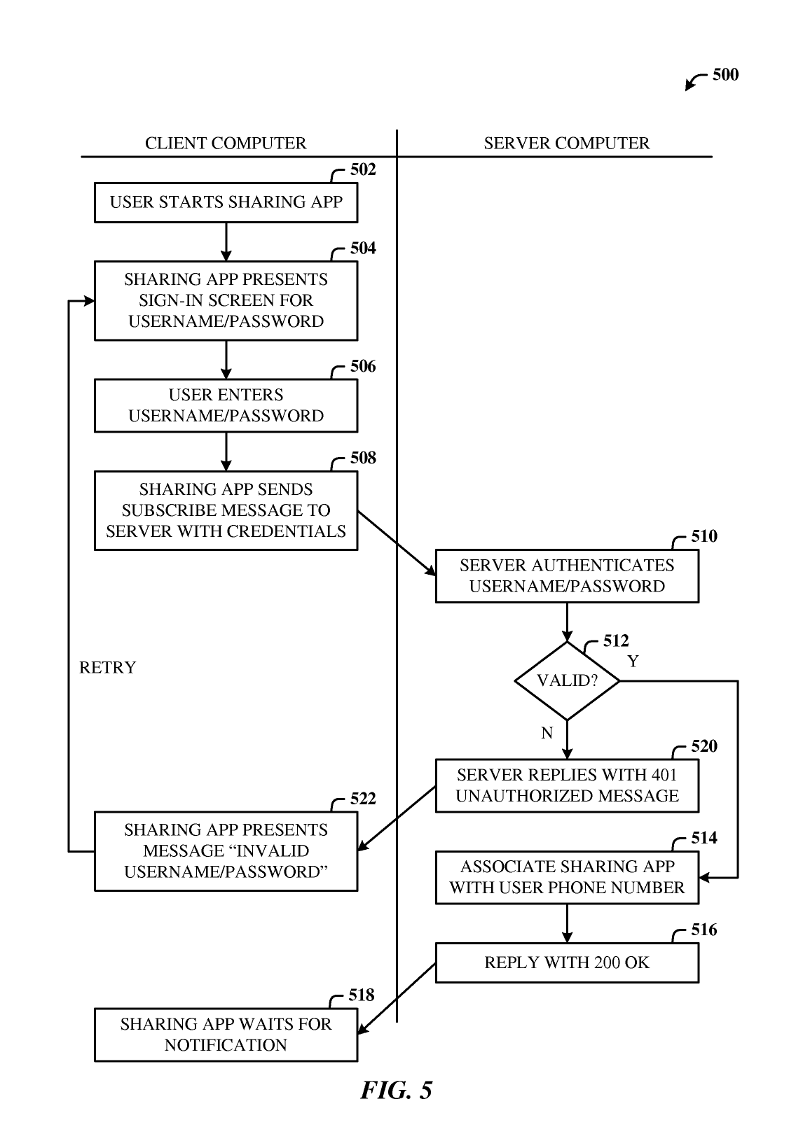

FIG. 5 illustrates a flow diagram 500 for an exemplary subscription process for data sharing session. At 502, the user starts the sharing application. At 504, the sharing application presents a sign-in screen for receiving a username and password. At 506, the user enters the username and password. At 508, the sharing application sends a subscribe message to the rendezvous server. At 510, on the server-side the server authenticates the username and password. At 512, if valid, flow is to 514 to associate the sharing applications with the user phone number. At 516, the server replies to the client sharing application with a “200 OK” message. At 518, on the client-side, the sharing application waits for notification. If the server-side authentication is not valid at 512, flow is to 520 where the server replies to the client sharing application with a “401 Unauthorized” message. At 522, the client sharing application then presents an “Invalid Username/Password” message to the client user. The client then retries the process by flowing back to 504 to again, present the sign-in screen.

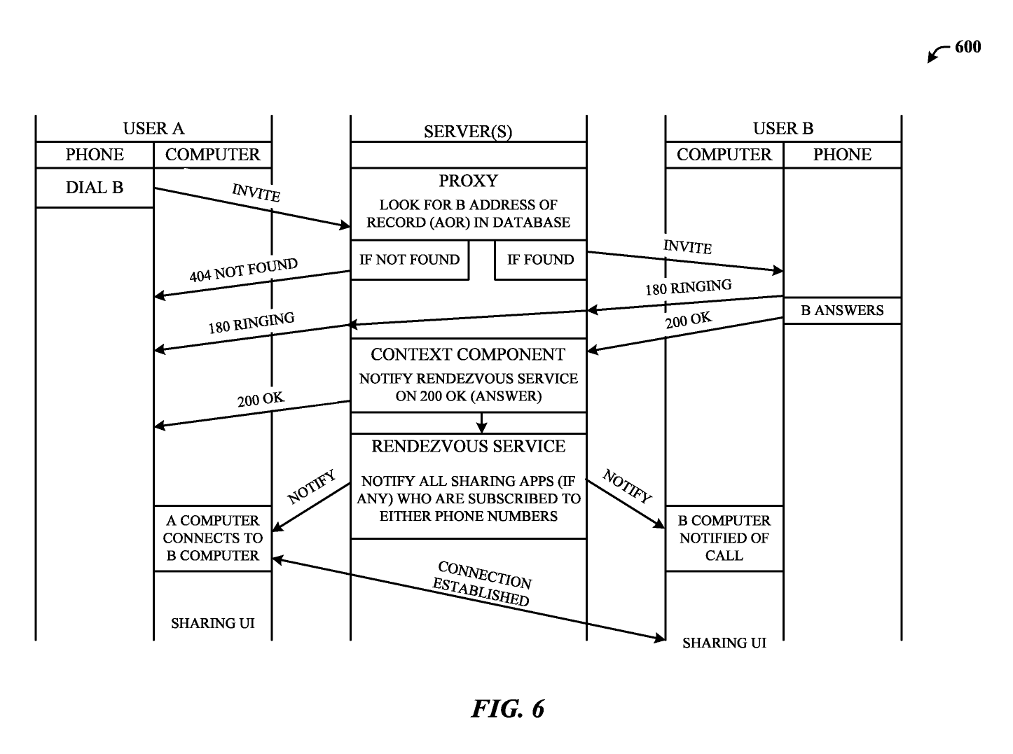

FIG. 6 illustrates a flow diagram 600 for an exemplary notification process after the subscription process 500 of FIG. 5. The notification process is between two users: a user A and a user B. However, it is to be understood that a similar notification process can occur between more than two users. Additionally, the users can be IP phone users, analog phone users, non-IP phones users, or any combination thereof. The diagram 600 shows SIP messaging; however, it is not a requirement that the disclosed architecture be imposed only in a SIP environment.

Each user (A and B) has a phone for voice communications and a computer for data sharing. User A initiates a voice session with user B. This can be initiated manually via the user A phone, phone A base station, user A website, user telecom provider, client application on user A computer, and so on. The SIP INVITE message is sent to a proxy server. In this example a single proxy server is shown although multiple proxy servers may be in the signaling path. The proxy server checks for user B's Address of Record (AoR) in its database. If the AoR is found, the proxy forwards the INVITE request to user B's phone. The phone returns a RINGING message to the proxy with forwards it on to user A's phone. When user B answers the phone, an OK message is sent to the proxy which both forwards it to user A phone to finalize the voice connection and the Context Component informs the Rendezvous Service of a connection between user A and user B. The Rendezvous Service checks in its database if there are Sharing Agents associated with each user and if so, notifies each user's Sharing Agent with the network connection information of the other users' Sharing Agents. The Sharing Agents connect to each other over the network and start a Data Sharing Session.

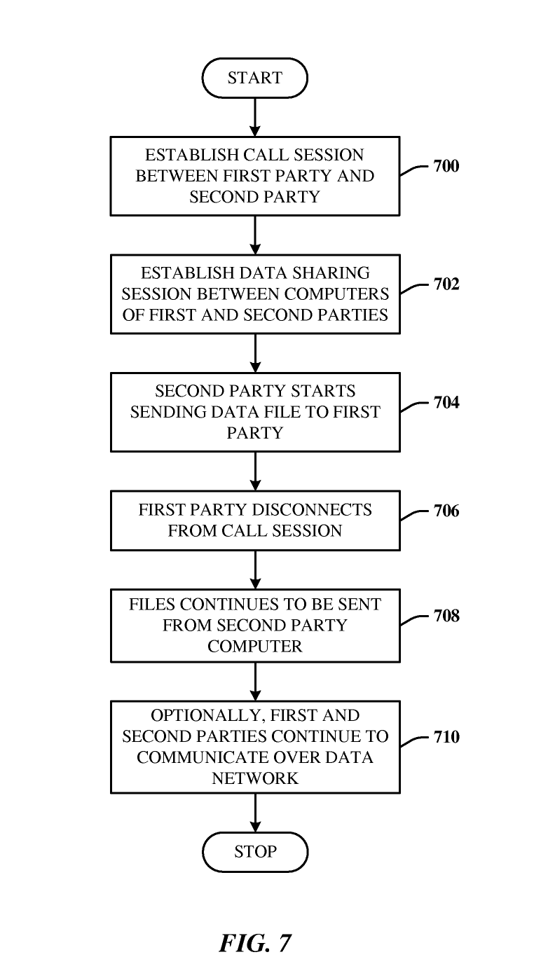

FIG. 7 illustrates a method of data sharing based on a phone call. At 700, a call session is established between a first party and a second party although more than two parties can join in a data sharing session. At 702, a data sharing session is established between computers of the first and second parties. At 704, the second party starts sending a file to the first party. At 706, the first party disconnects from the call session. At 708, the file continues to be sent from the second party computer to the first party computer. At 710, thereafter the first and second parties communicate over the data sharing network via network protocols.

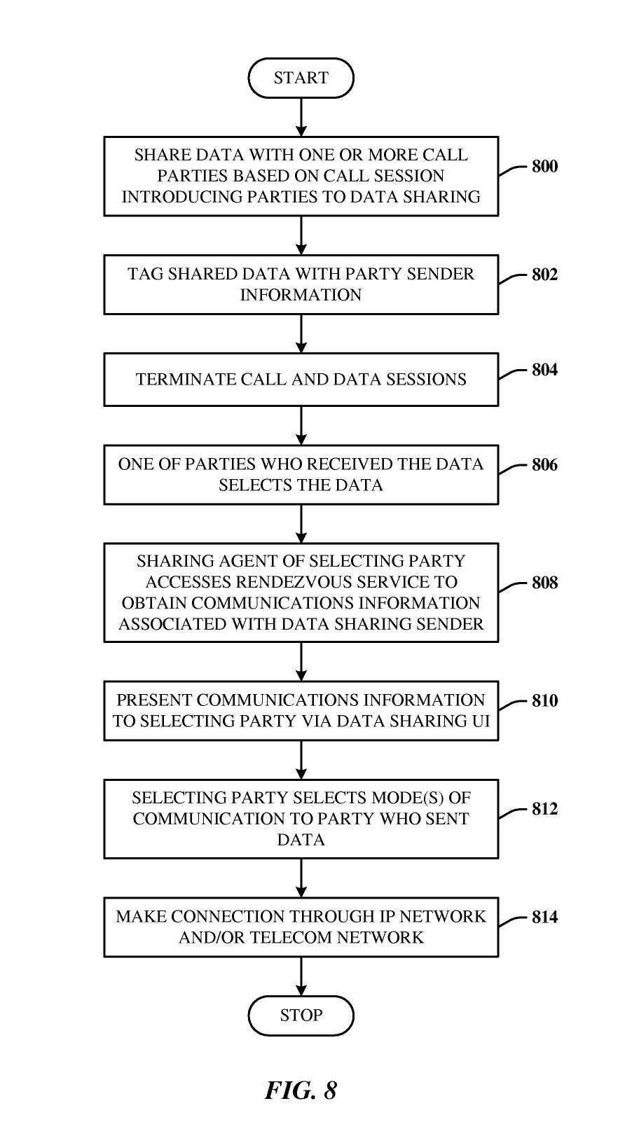

FIG. 8 illustrates a method of establishing a communications session based on shared data. At 800, data is shared with one or more call parties based on the call session introducing the parties to the data sharing session. At 802, the data being shared is tagged with party information relating to the party sending the shared data. At 804, the call session and data sharing session terminate. At 806, one of the parties who received the shared data selects the data. At 808, the sharing agent of the party selecting the data accesses the rendezvous service to obtain communications information associated with the data sharing sender. The communications information can be an email address, website address, phone number, text messaging alias (or user ID), SMS (short message service) address, MMS (multimedia message service) address, SIP address, cellphone number, and so on, that provides a means for accessing the many different types of communications technologies and protocol available. At 810, the communications information is presented to the selecting party via the data sharing UI. At 812, the party selects the mode for connecting and communicating with the party who sent the data. At 814, the connection is made through an IP network and/or a telecom network.

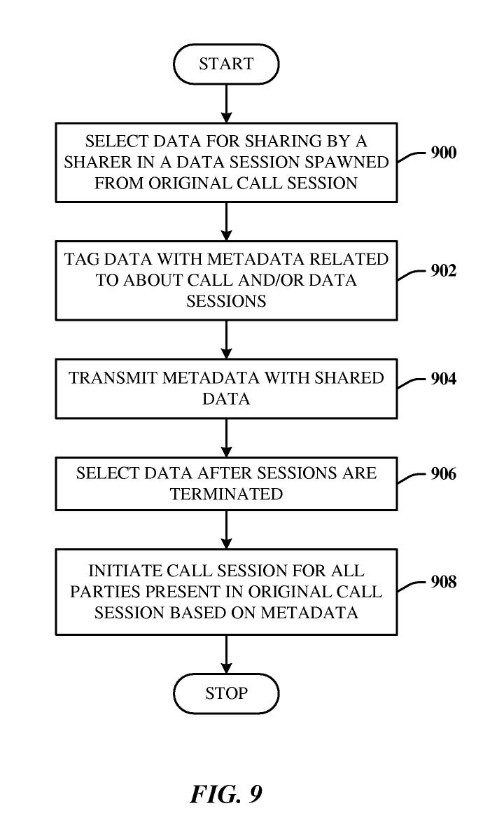

FIG. 9 illustrates a method of identifying shared data. At 900, data is selected for sharing (by a party who is designated the sharer) in a data session initiated via an original call session. At 902, the data is tagged with metadata that includes sharer name, time, date, other parties to the call session, etc., as desired. This can be a configurable feature to select the composition of the metadata or settings that are default. At 904, the metadata is transmitted with the data shared. At 906, the data is selected at a later time after the voice session was terminated. At 908, a call session is initiated for all parties present in the original call session based on the metadata. It is to be understood that there can be multiple participants sharing data with no particular participant designated as a sharer, but the sharer's information tagged to the data. For example, a first sharing participant can drag-and-drop pictures while a second sharing participant drags-and-drops audio files, in which case all participants will receive the pictures and the audio files, and appropriately tagged.

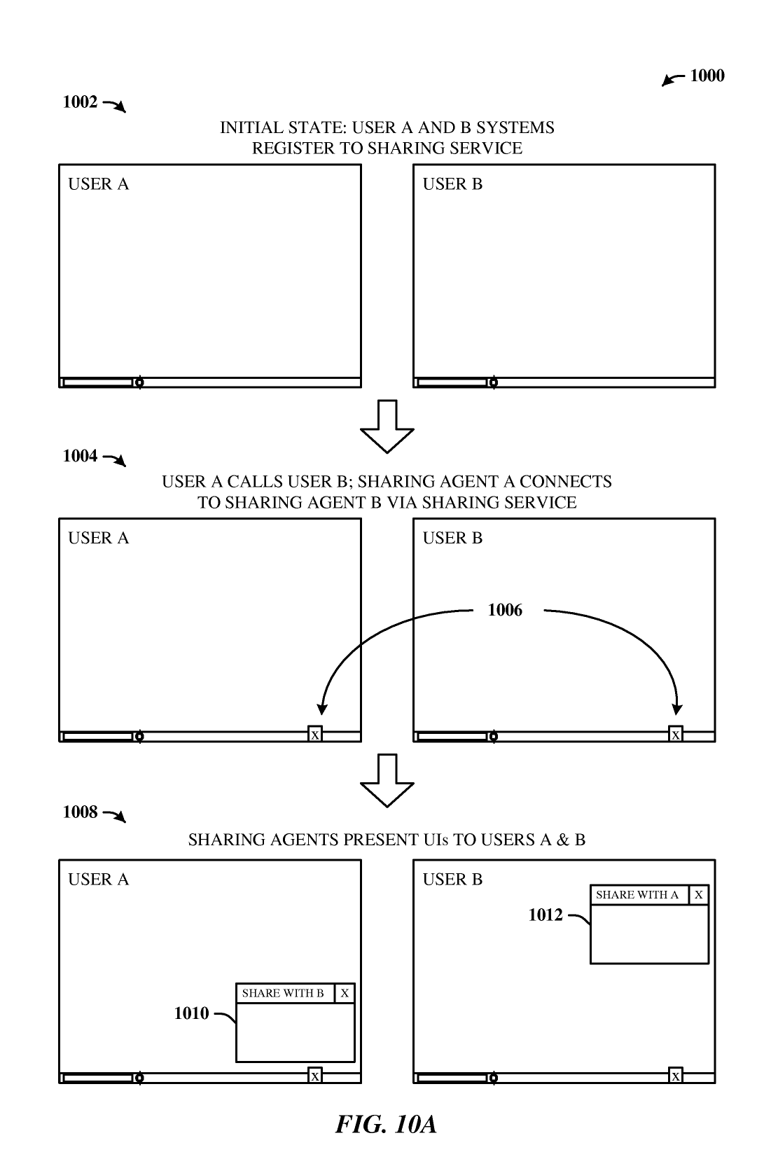

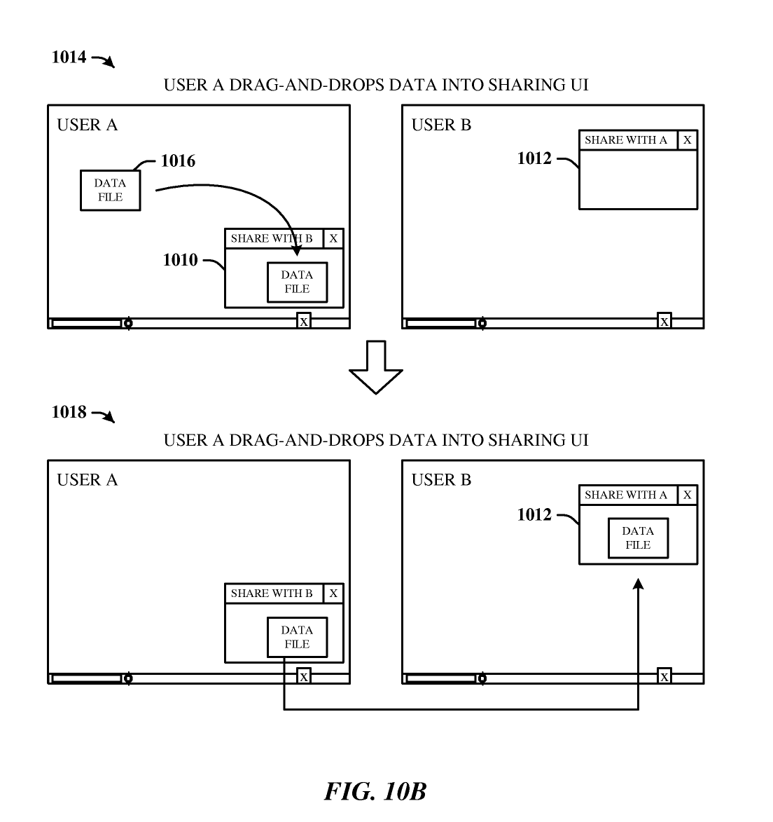

FIG. 10A and FIG. 10B illustrate a set of UI panels 1000 for two users in an exemplary data sharing scenario. At 1002, in an initial state, user A and user B systems register to the sharing service (not shown). At 1004, user A calls user B, and the associate sharing agents connect via the sharing service. As a result, sharing icons 1006 or other suitable indicators can be place in the systray of each UI panel. At 1008, the sharing agent of user A presents an A sharing window 1010 and the sharing agent of user B presents a B sharing window 1012. Moving to FIG. 10B, at 1014, user A drag-and-drops a data file 1016 into the user A sharing window 1010 to share the file 1016 with user B. At 1018, the data file 1016 is transmitted and appears in the user B sharing window 1012.

In another multi-party scenario, the sharing UI presents multiple sharing panels such that user A can drag the file 1016 into each of multiple panels to send the data file 1016 to many file recipients.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

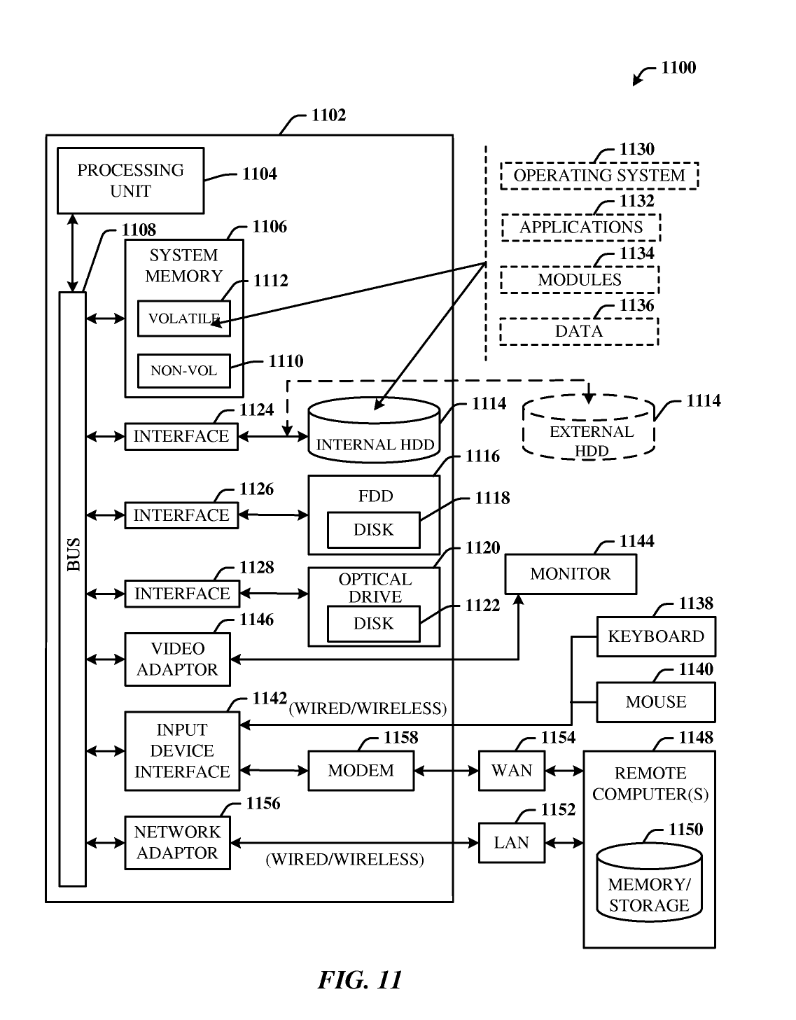

Referring now to FIG. 11, there is illustrated a block diagram of a computing system 1100 operable to execute the disclosed call session/data sharing architecture. In order to provide additional context for various aspects thereof, FIG. 11 and the following discussion are intended to provide a brief, general description of a suitable computing system 1100 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102 having a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 can include non-volatile memory (NON-VOL) 1110 and/or volatile memory 1112 (e.g., random access memory (RAM)). A basic input/output system (BIOS) can be stored in the non-volatile memory 1110 (e.g., ROM, EPROM, EEPROM, etc.), which BIOS contains the basic routines that help to transfer information between elements within the computer 1102, such as during start-up. The volatile memory 1112 can also include a high-speed RAM such as static RAM for caching data.

The computer 1102 further includes an internal hard disk drive (HDD) 1114 (e.g., EIDE, SATA), which internal HDD 1114 may also be configured for external use in a suitable chassis, a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as a DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1112, including an operating system 1130, one or more application programs 1132, other program modules 1134, and program data 1136. The one or more application programs 1132, other program modules 1134, and program data 1136 can include the component described herein with respect to the figures (e.g., communications component 102, context component 108, and sharing component 110), phone agents, sharing applications or agents, SIP proxies, rendezvous service, and sharing UIs, for example.

All or portions of the operating system, applications, modules, and/or data can also be cached in the volatile memory 1112. It is to be appreciated that the disclosed architecture can be implemented with various commercially available operating systems or combinations of operating systems.

A user can enter commands and information into the computer 1102 through one or more wire/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, etc.

A monitor 1144 or other type of display device is also connected to the system bus 1108 via an interface, such as a video adaptor 1146. In addition to the monitor 1144, a computer typically includes other peripheral output devices (not shown), such as speakers, printers, etc.

The computer 1102 may operate in a networked environment using logical connections via wire and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, is connected to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, for example, a printer, scanner, desktop and/or portable computer, portable data assistant, vehicle-based personal computer, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A communications system, comprising:
a communications component for establishing a call session between two or more call parties;
a context component for determining contextual information of the call parties based on the call session; and
a sharing component for automatically establishing an independent data sharing session between call party systems based on the contextual information.

2. The system of claim 1, wherein the data sharing session continues after the call session is terminated.

3. The system of claim 1, wherein the context component includes a phone agent for interacting with the communications component to determine identifiers associated with the call parties.

4. The system of claim 3, wherein one or more of the call parties are in the call session or had been in the call session.

5. The system of claim 3, wherein the phone agent sends the identifiers of the call parties to the sharing component.

6. The system of claim 3, wherein the identifiers include at least one of a phone number, an email address, or an IP address.

7. The system of claim 1, wherein the context component includes a phone agent that operates from premises of a party, a telecom service provider network, or a third-party IP network provider.

8. The system of claim 1, wherein the sharing component includes sharing agents that interact to share the data between the call party systems.

9. The system of claim 1, wherein the sharing component includes a rendezvous service that maps a party identifier to a different party identifier.

10. The system of claim 1, wherein the sharing component includes a sharing UI that facilitates interaction between the call parties for sharing data between the call party systems.

11. A computer-implemented method of communicating data, comprising:
establishing a voice session between two or more parties to a phone call;
obtaining identifiers associated with the parties;
mapping the identifiers between the parties; and
establishing a data sharing session between two or more of the parties for sharing data and which data sharing session is independent of the voice session.

12. The method of claim 11, further comprising continuing the data sharing session beyond termination of the voice session.

13. The method of claim 11, further comprising automatically establishing a new voice session based on selection of the data shared during the voice session.

14. The method of claim 11, further comprising terminating the voice session and reestablishing the voice session based on data tagged during the terminated voice session.

15. The method of claim 11, further comprising establishing a new voice session with a party that was previously part of the voice session and presenting the data shared in association with the voice session during the new voice session.

16. The method of claim 11, further comprising terminating the data session and reestablishing the data session based on data tagged during the terminated data session, the data shared over an IP network and the voice session over a telephone network.

17. The method of claim 11, further comprising tagging the shared data with information associated with a party to the phone call.

18. The method of claim 11, further comprising presenting a sharing UI for interacting with the data sharing session.

19. The method of claim 11, wherein the identifiers map a party identifier of a data network to a party identifier of a voice network.

20. A computer-implemented system, comprising:
computer-implemented means for establishing a voice session between parties to a phone call;
computer-implemented means for obtaining identifiers associated with the parties;
computer-implemented means for mapping the identifiers between the parties; and
computer-implemented means for establishing a data sharing session between the parties for sharing data and which data sharing session is independent of the voice session.
